(19) United States
(12) Patent Application Publication
(10) Pub. No.: US 2025/0005329 A1
(43) Pub. Date: Jan. 2, 2025

(54) Context-Driven Generation of Diverse Questions

(71) Applicant: eBay Inc., San Jose, CA (US)

(72) Inventors: Haggai Roitman, Yokneam Ilit (IL); Alexander Nus, Herelizya (IL); Yotam Eschel, Ein Iron (IL); Uriel Singer, Harish (IL)

(73) Assignee: eBay Inc., San Jose, CA (US)

(21) Appl. No.: 18/216,031

(22) Filed: Jun. 29, 2023

(51) Int. Cl. G06N 3/0455; G06N 3/08

(52) U.S. Cl. CPC G06N 3/0455; G06N 3/08

(57) ABSTRACT

In accordance with techniques for context-driven generation of diverse questions, a machine learning model receives a first target question, a second target question, and a context. Based on the context and one or more words of the first target question, a first decoder of the machine learning model outputs a first representation of candidate words to follow the one or more words of the first target question. Based on the context and one or more words of the second target question, a second decoder of the machine learning model outputs a second representation of candidate words to follow the one or more words of the second target question. The machine learning model is fine-tuned to generate diverse questions for a given context based on a diversity loss that captures a degree of variance between the first representation and the second representation.

### BACKGROUND

Machine learning refers to techniques implemented by computing devices to make predictions or decisions based on data without being explicitly programmed to do so, e.g., by a user. To do so, a machine learning model is trained using training data. A machine learning model refers to a computer representation that can be tuned (e.g., trained and retrained) based on inputs to approximate unknown functions. In particular, the term machine learning model can include a model that utilizes algorithms to learn from, and make predictions on, known data by analyzing training data to learn and relearn to generate outputs that reflect patterns and attributes of the training data. In various examples, machine learning models include functionality for question generation. However, conventional question generation techniques ignore the task of question diversification during a training phase of a machine learning model. As a result, conventionally-trained machine learning models generate questions that are too generic to convey meaningful context with respect to a specific question area for which the questions are generated.

### SUMMARY

Techniques for context-driven generation of diverse questions are described. These techniques support fine-tuning of a machine learning model for the task of generating diverse questions for a given context. As part of this, the machine learning model receives training data in the form of a triplet that includes a first target question, a second target question, and a context. The context, for example, is information with respect to which the first target question and the second target question are asked. Based on the context and one or more words of the first target question, a first decoder of the machine learning model generates a first representation of candidate words to follow the one or more words of the first target question. Based on the context and one or more words of the second target question, a second decoder of the machine learning model generates a second representation of candidate words to follow the one or more words of the second target question. Furthermore, fine-tuning logic is employed to train the machine learning model based on a diversity loss that captures a degree of variance between the first representation and the second representation.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of a digital medium environment in an example implementation that is operable to employ techniques for context-driven generation of diverse questions.

FIG. 2 depicts a system in an example implementation showing operation of a training module to train a machine learning model.

FIG. 3 depicts a system in an example implementation showing operation of a question generation module to use the machine learning model.

FIG. 4 depicts an example in which a client device leverages the machine learning model as part of one or more digital services made available to the client device via a service provider system.

FIG. 5 is a flow diagram depicting a procedure in an example implementation of context-driven generation of diverse questions.

FIG. 6 illustrates an example system including various components of an example device that can be implemented as any type of computing device as described and/or utilized with reference to FIGS. 1-5 to implement embodiments of the techniques described herein.

### DETAILED DESCRIPTION

### Overview

Machine learning models are often implemented for question generation. In one or more scenarios, these machine learning models are implemented in conjunction with digital services made available to client devices via a service provider system. As an example of this functionality, a machine learning model is employed to automatically generate questions for inclusion within a “comments” section or a “question and answer” section of a product listing published via one or more digital services, e.g., digital marketplace services and/or auction services. Conventional techniques for fine-tuning a machine learning model for question generation, however, ignore the task of question diversification until model inference, i.e., after the machine learning model has been trained/fine-tuned. Therefore, a conventionally-trained machine learning model generates questions that lack particularity with respect to a given context.

Continuing with the example in which the machine learning model generates questions for a “question and answer” section of a product listing, a conventionally-trained question generation model elects to generate questions that are generally applicable to a variety of products, e.g., “what are the dimensions of <product>?” and “what is the warranty on <product>?” Furthermore, over multiple iterations, the conventionally-trained model elects to generate the same or similar questions with respect to a plurality of different products within a product class, i.e., the generated questions lack global diversity. Incomplete and/or inadequate information within the “question and answer” section often persuade digital marketplace users to explore different sources (e.g., different digital marketplaces) offering the same or similar items.

Accordingly, techniques for context-driven generation of diverse questions are described which overcome the drawbacks of conventional techniques. Broadly, these techniques support fine-tuning of a machine learning model for the task of generating diverse questions for a given context. In the following discussion, non-limiting examples are discussed in which the machine learning model is trained and used for generating questions for integration into a “comments” section and/or “question and answer” section of a product listing. However, it is to be appreciated that the described techniques are implementable to train and use the machine learning model for generating questions for any one or more of a wide variety of contexts.

In accordance with the described techniques, the machine learning model receives training data in the form of a triplet that includes a first target question, a second target question, and a context. In an example, the context includes information retrieved from a product listing, e.g., a title of the product listing, a description of the product listing, a list of features of the product listing, a display photo of the product listing, and so on. Moreover, the first target question and the second target question are questions retrieved from the “comments” section and/or “question and answer” section of the product listing. Therefore, the target questions are questions that are asked by users of the digital marketplace services with respect to the product listing.

In one or more implementations, the machine learning model is a transformer including a first decoder and a second decoder, and the decoders each have a plurality of layers. Broadly, the first decoder is employed to predict a next word to follow one or more words of the first target question. As part of this, a first layer of the first decoder receives, as conditioning, the one or more words of the first target question, and outputs a first representation (e.g., a matrix representation in latent space) of first candidate words to follow the one or more words of the first target question. Each subsequent layer of the first decoder receives, as conditioning, the context and the first representation as output by a previous layer of the first decoder. Further, the first representation as output by a final layer of the first decoder is provided, as input, to a conditional generation head of the first decoder. The conditional generation head converts the first representation into a first probability distribution, in which probabilities are assigned to respective words (e.g., first candidate words) of a library of words of the machine learning model. The probabilities indicate measures of likelihood that respective first candidate words are the next word to follow the one or more words of the first target question.

The second decoder is similarly employed to predict a next word to follow one or more words of the second target question. For example, a first layer generates a second representation (e.g., a matrix representation in latent space) of second candidate words to follow the one or more words of the second target question based on the context and the one or more words of the second target question. Further, the second representation is propagated through the plurality of layers of the second decoder, in which each subsequent layer is conditioned on the context and the second representation output by a previous layer of the second decoder. A conditional generation head of the second decoder then receives the second representation as output by a final layer of the second decoder, and determines a probability distribution in which second candidate words are assigned probabilities of being the next word to follow the one or more words of the second target question.

Fine-tuning logic is employed to fine-tune the machine learning model to generate questions that are relevant to a given context. As part of this, the fine-tuning logic calculates a first relevance loss based on a probability assigned to a respective one of the first candidate words that matches the next word of the first target question. Similarly, the fine-tuning logic calculates a second relevance loss based on a probability assigned to a respective one of the second candidate words that matches the next word of the second target question. Increased values for the probabilities assigned to the matching candidate words lead to decreased values for the relevance losses.

The fine-tuning logic is further employed to fine-tune the machine learning model to generate diverse questions. As part of this, the fine-tuning logic calculates pairwise diversity scores which capture degrees of variance between the first and second representations as output by corresponding layers of the first and second decoders, respectively. By way of example, a first pairwise diversity score is determined by applying a difference metric to the first representation and the second representation as output by a first layer of the first and second decoders, respectively, a second pairwise diversity score is determined by applying a difference metric to the first representation and the second representation as output by a second layer of the first and second decoders, respectively, and so on. The fine-tuning logic further calculates a diversity loss which is an average of the pairwise diversity scores.

In accordance with the described techniques, the fine-tuning logic updates the machine learning model to minimize the relevance losses and the diversity loss. By doing so, the machine learning model learns to generate candidate words that are relevant to (e.g., likely to be asked with respect to) a given context. This is achieved by updating the machine learning model to maximize correspondence of the candidate words with the ground truth words of the first and second target questions based on the relevance losses. Further, the machine learning model learns to maximize semantic diversity between questions generated for a given context. This is achieved by updating the machine learning model to maximize dissimilarity between the representations of candidate words output by the different decoders.

Thus, the fine-tuned machine learning model is deployable to generate questions having increased particularity with respect to a given context and having increased global diversity, as compared to conventionally-trained question generation models. In the product listing example, for instance, the machine learning model generates questions for integration into a “comments” section and/or “question and answer” section that are particular to the subject product and its usage. Due to this particularity, questions generated by the machine learning model for different product listings in a class of products (e.g., electronics) are different. This contrasts with the questions generated by conventionally-trained models which are generally applicable to most, if not all, products in a product class. Due to the improved question quality in the generated questions, digital marketplace users are less likely to explore other sources (e.g., other digital marketplaces) for products, thereby increasing conversion rates for product listings on the digital marketplace. Further discussion of these and other examples is included in the following discussion and shown in corresponding figures.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Feature Engineering Logic Generation and Simulation

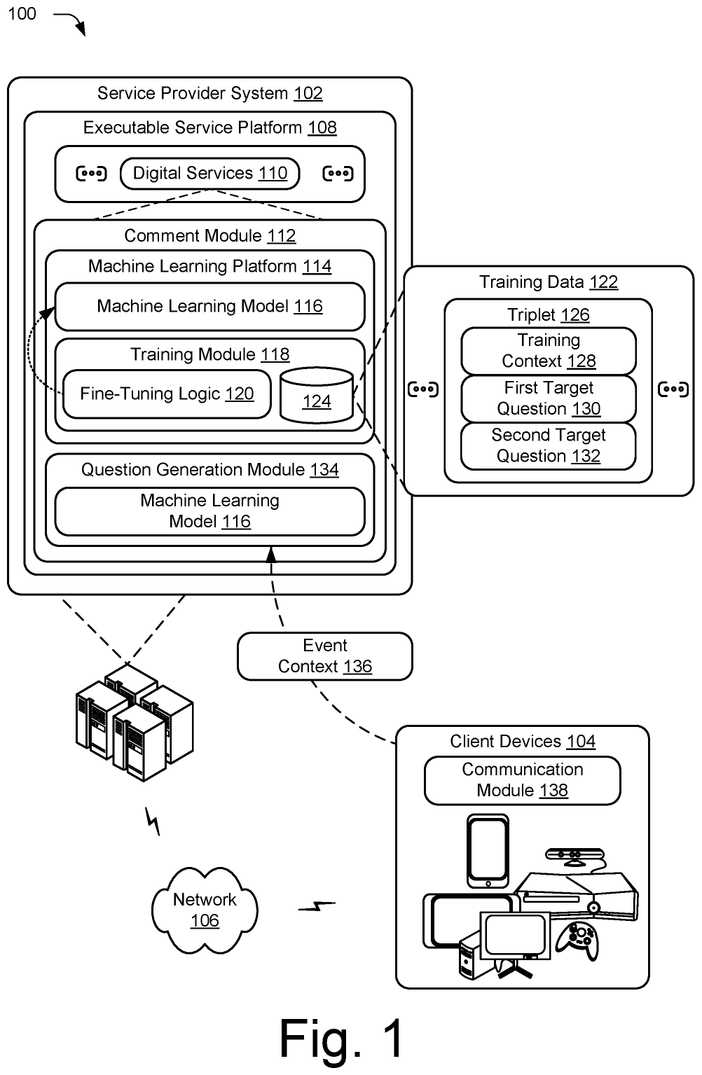

FIG. 1 is an illustration of a digital medium environment 100 in an example implementation that is operable to employ techniques for context-driven generation of diverse questions. The illustrated environment 100 includes a service provider system 102, and a plurality of client devices 104 that are communicatively coupled, one to another, via a network 106. Computing devices that implement the service provider system 102 and the client devices 104 are configurable in a variety of ways.

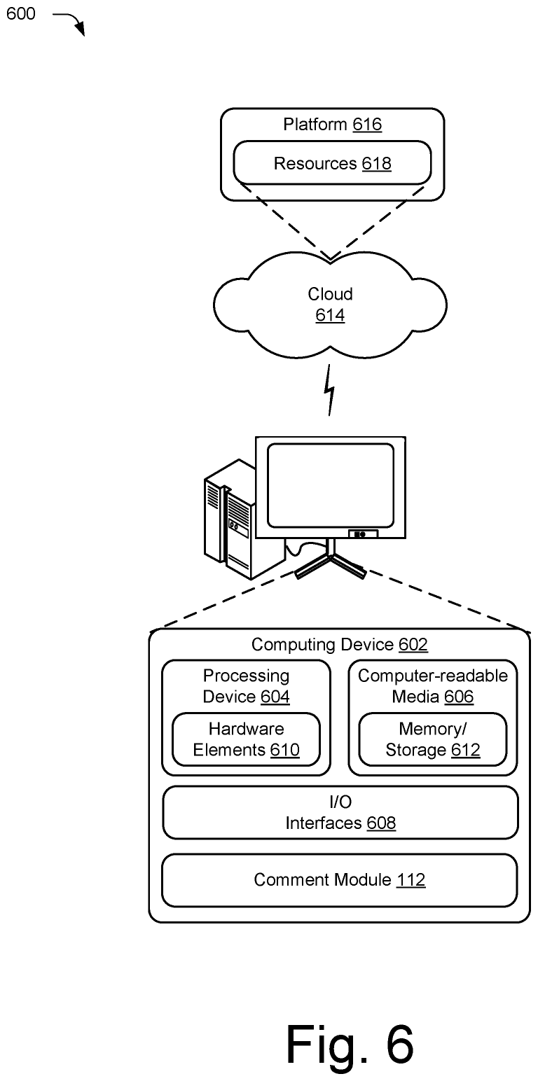

A computing device, for instance, is configurable as a desktop computer, a laptop computer, a mobile device (e.g., assuming a handheld configuration such as a tablet or mobile phone), and so forth. Thus, a computing device ranges from full resource devices with substantial memory and processor resources (e.g., personal computers, game consoles) to a low-resource device with limited memory and/or processing resources (e.g., mobile devices). Additionally, a computing device is also representative of a plurality of different devices, such as multiple servers utilized by a business to perform operations “over the cloud” as illustrated for the service provider system 102 and as described in FIG. 6.

The service provider system 102 includes an executable service platform 108. The executable service platform 108 is configured to implement and manage access to digital services 110 “in the cloud” that are accessible by the client devices 104 via the network 106. Thus, the executable service platform 108 provides an underlying infrastructure to manage execution of digital services 110, e.g., through control of underlying computational resources.

The executable service platform 108 supports numerous computational and technical advantages, including an ability of the service provider system 102 to readily scale resources to address wants of an entity associated with the client devices 104. Thus, instead of incurring an expense of purchasing and maintaining proprietary computer equipment for performing certain computational tasks, cloud computing provides the client devices 104 with access to a wide range of hardware and software resources so long as the client has access to the network 106.

Digital services 110 can take a variety of forms. Examples of digital services include social media services, document management services, storage services, media streaming services, content creation services, productivity services, digital marketplace services, auction services, and so forth. In some instances, the digital services 110 are implemented at least partially by a comment module 112 that supports functionality for creating, editing, responding to, and/or posting comments relative to a given context. In various examples, the comment module 112 enables users of the client devices 104 to comment, ask, and/or answer questions regarding a product listing of the digital marketplace services and/or the auction services, regarding a media content item of the media streaming services, regarding a social media post of the social media services, and so on. Accordingly, the comment module 112 is implementable in conjunction with a plurality of different digital services 110 without departing from the spirit or scope of the described techniques.

In one or more implementations, the comment module 112 implements a machine learning platform 114, which is representative of functionality to train, retrain, and use a machine learning model 116 for a task, e.g., the task of generating diverse and relevant questions for a given context. Notably, a machine learning model 116 refers to a computer representation that can be tuned (e.g., trained and retrained) based on inputs to approximate unknown functions. The machine learning model 116 is configurable to utilize algorithms to learn from, and make predictions on, known data by analyzing training data to learn and relearn to generate outputs that reflect patterns and attributes of the training data. Examples of machine learning models include transformers, neural networks (e.g., deep learning neural networks), convolutional neural networks (CNNs), long short-term memory (LSTM) neural networks, decision trees, and so forth.

In one or more implementations, the machine learning model 116 is a pre-trained natural language processing model. In various examples, the pre-trained natural language processing model is a transformer having an encoder-decoder architecture. Examples of such pre-trained natural language processing models include, but are not limited to, T5, BART, Pegasus, and ProphetNet models. In one or more additional examples, the pre-trained natural language processing model is a transformer having a decoder architecture, e.g., a transformer that includes a decoder, but does not include an encoder. Examples of such pre-trained natural language processing models, include, GPT-2, GPT-3, CTRL, and Transformer-XL models.

The machine learning platform 114 is illustrated as including a training module 118, which is representative of functionality to train and/or retrain the machine learning model 116 for a task. To do so, the training module 118 implements fine-tuning logic 120. In accordance with the described techniques, the fine-tuning logic 120 represents an algorithm for fine-tuning the machine learning model 116 (e.g., the pre-trained natural language processing model) for the task of generating diverse and relevant questions for a given context.

As part of this, the training module 118 maintains training data 122 in a storage device 124. As shown, the training data 122 includes a plurality of triplets 126, each including a training context 128, a first target question 130, and a second target question 132. Broadly, the training context 128 refers to any information regarding a subject with respect to which the first target question 130 and the second target question 132 are asked. In one or more implementations, the training data 122 is generated through execution of the digital services 110 by the client devices 104.

In an example in which the digital services 110 includes digital marketplace services and/or auction services, for instance, one or more triplets 126 are retrieved from a plurality of product listings. For instance, the training module 118 retrieves a training context 128, a first target question 130, and a second target question 132 from a product listing, and stores the retrieved data as a triplet 126 in the storage device 124. In this example, the subject with respect to which the questions 130, 132 are asked is the product of the product listing, and as such, the training context 128 includes information that is relevant to the product. By way of example and not limitation, the training context 128 includes a title of the product listing, a picture of the product listing, a description of the product listing, and/or a list of product features of the product listing. Further, the first target question 130 and the second target question 132 are questions obtained from a “comments” section and/or a “question and answer” section of the product listing. Therefore, in one or more examples, the first target question 130 and the second target question 132 are posed by users of the client devices 104 through execution of the comment module 112.

Given a respective triplet 126, the training module 118 employs a first decoder of the machine learning model 116 to predict a next word to follow one or more words of the first target question 130 based on the training context 128 and the one or more words of the first target question 130. As part of this, the first decoder generates a first representation (e.g., a matrix representation in latent space) of first candidate words to follow the one or more words of the first target question 130. Moreover, the first decoder converts the first representation to a probability distribution, in which the first candidate words are assigned probabilities of being the next word to follow the one or more words of the first target question 130.

Similarly, the training module 118 employs a second decoder of the machine learning model 116 to predict a next word to follow one or more words of the second target question based 132 based on the training context 128 and the one or more words of the second target question 132. As part of this, the second decoder generates a second representation (e.g., a matrix representation in latent space) of second candidate words for inclusion in the second question. Moreover, the second decoder converts the second representation to a probability distribution, in which the second candidate words are assigned probabilities of being the next word to follow the one or more words of the second target question 132.

To fine-tune the machine learning model 116 for the task of diverse and relevant question generation, the fine-tuning logic 120 calculates a first relevance loss based on a probability assigned to a respective one of the first candidate words that matches the next word of the first target question 130. Moreover, the fine-tuning logic calculates a second relevance loss based on a probability assigned to a respective one of the second candidate words that matches the next word of the second target question 132. Increased probabilities assigned to the matching candidate words leads to decreased values for the relevance losses. In addition, the fine-tuning logic 120 is configured to calculate a diversity loss which captures a degree of variance between the first representation and the second representation. Notably, a value of the diversity loss decreases based on the first representation and the second representation being increasingly diverse or dissimilar.

The fine-tuning logic 120 updates the machine learning model 116 to reduce the first relevance loss, the second relevance loss, and the diversity loss. By doing so, the machine learning model 116 learns to generate diverse and relevant questions for a given context. For example, the fine-tuning logic 120 enforces the machine learning model 116 to generate questions that are relevant to (e.g., likely to be asked with respect to) a given context by rewarding or penalizing the machine learning model based on correspondence of candidate words with the ground truth words of the first and second target questions 130, 132. Moreover, the fine-tuning logic 120 enforces the machine learning model 116 to minimize semantic similarity between questions generated for a given context based on the diversity loss.

As shown, the comment module 112 further includes a question generation module 134, which is representative of functionality for generating questions responsive to an event context 136 being received. By way of example, the client devices 104 include a communication module 138 having functionality to send communications, such as the event context 136, to the service provider system 102 over the network 106. In one or more implementations, the event context 136 includes the same and/or similar information as the training context 128. However, the event context 136 is generated as part of an event to generate and/or publish digital content with respect to which one or more questions are to be automatically generated by the question generation module 134.

In a non-limiting example, the event corresponds to a user of the client device 104 publishing a product listing using the digital marketplace and/or auction services. In response to the publication, the client device 104 communicates the event context 136 (e.g., the title of the product listing, the description of the product listing, product details/features of the product listing, and so on) to the question generation module 134 using the communication module 138.

Further, the question generation module 134 leverages the fine-tuned machine learning model 116 to automatically generate relevant and diverse questions based on the event context 136, and output the generated questions. Continuing with the previous example, the generated questions are communicated to the client device 104 of the publisher of the product listing, along with a user-selectable option to include the generated questions in a “comments” section and/or “question and answer” section of the product listing. Additionally or alternatively, the question generation module 134 automatically inserts the generated questions into the “comments” section and/or “question and answer” section of the product listing.

Although training context 128 and the event context 136 are described above and below as relating to product listings of digital marketplace services and/or auction services, these examples are not to be construed as limiting. Instead, the training data 122 includes triplets 126 retrieved from content items of any of a variety of different digital services 110 without departing from the spirit or scope of the described techniques. Moreover, the event context 136 includes information relating to published digital content of any of a variety of digital services 110, without departing from the spirit or scope of the described techniques.

Moreover, although examples are depicted and described herein in which the machine learning model 116 is trained and used for generating two diverse and relevant questions by two decoders, these examples are not to be construed as limiting. Indeed, the described techniques are implementable to train and use the machine learning model 116 to generate two or more diverse and relevant questions using two or more parallel decoders, in variations. Furthermore, while examples are depicted described herein for generating diverse questions for a given context, it is to be appreciated that the described techniques are not limited to questions. Instead, the described techniques are applicable to train and use the machine learning model 116 for generating diverse sentences (e.g., and not just questions) for a given context.

Conventional techniques for fine-tuning a machine learning model 116 for question generation often ignore the task of question diversification until model inference, i.e., after the machine learning model 116 has been trained/fine-tuned. As a result, machine learning models 116 fine-tuned in this way often elect to generate question that are sufficiently broad to be applicable to most, if not all, contexts within a class of contexts. In an example in which a conventionally fine-tuned machine learning model 116 is leveraged to generate questions for a product of a product listing, the conventionally fine-tuned model 116 generates the following questions: “what are the dimensions of <product>?” and “what is the warranty on <product>?” While these questions are nominally relevant, the questions are too generic to convey meaningful context with respect to the specific product and its usage.

Given this, a conventionally fine-tuned machine learning model 116 often elects to generate a relatively small set of generally relevant questions over a class of contexts. Accordingly, question sets generated by a conventionally fine-tuned machine learning model for a class of contexts lack global diversity, i.e. the same or similar generic questions are generated for many contexts in the class. In contrast, the described fine-tuning logic 120 causes the machine learning model 116 to learn question diversification during a training phase of the machine learning model 116, e.g., by updating the machine learning model 116 to minimize the diversity loss. By doing so, the question generation module 134 generates questions having increased particularity with respect to a given context, and having increased global diversity.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure.

Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Question Diversification Features

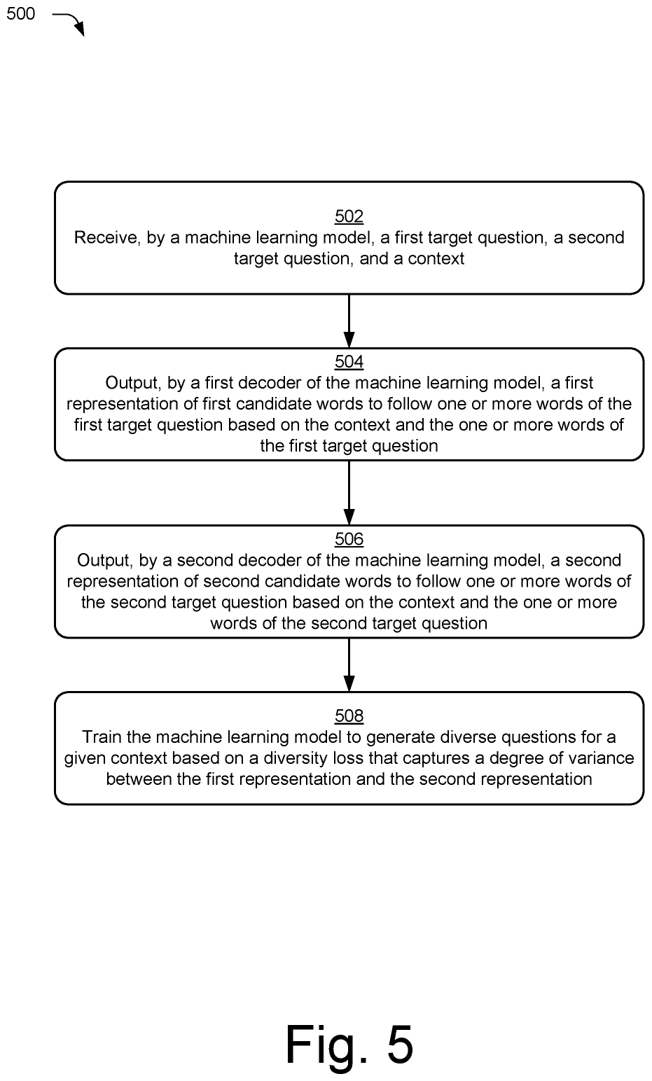

The following discussion describes techniques for context-driven generation of diverse questions that are implementable utilizing the previously described systems and devices. Aspects of each of the procedures are implemented in hardware, firmware, software, or a combination thereof. The procedures are shown as a set of blocks that specify operations performed by one or more devices and are not necessarily limited to the orders shown for performing the operations by the respective blocks. In portions of the following discussion, reference will be made to FIGS. 1-4 in parallel with procedure 500 of FIG. 5.

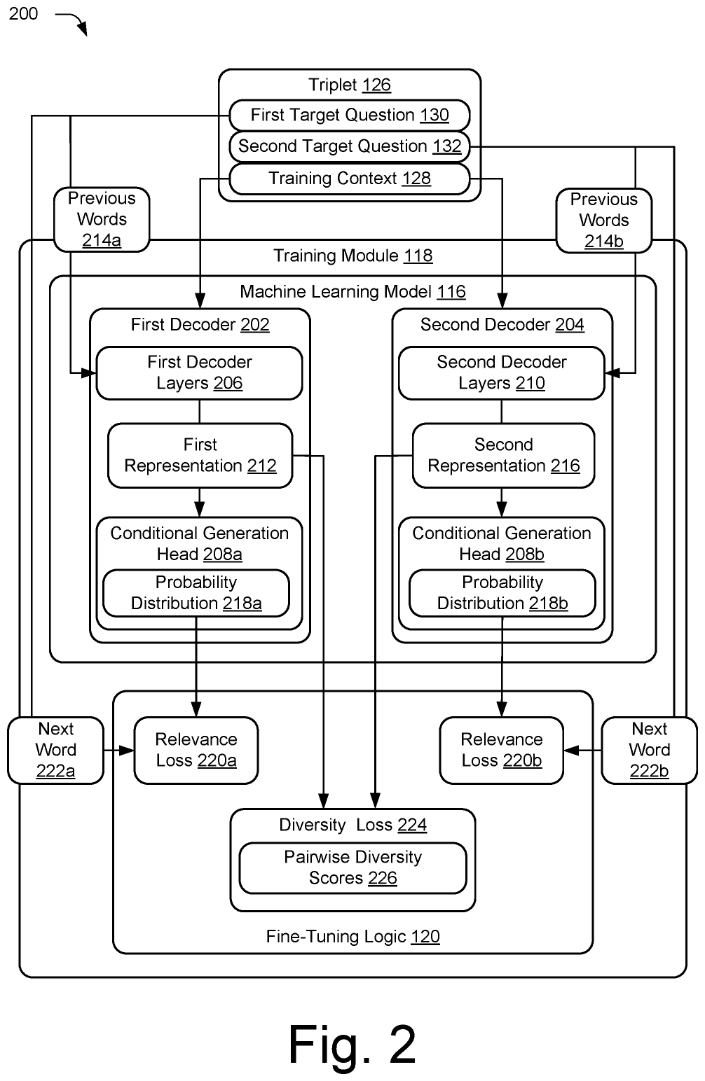

FIG. 2 depicts a system 200 in an example implementation showing operation of a training module to train a machine learning model. The machine learning model 116 is illustrated as including a first decoder 202 and a second decoder 204. Moreover, the first decoder 202 includes first decoder layers 206 and a conditional generation head 208a, and the second decoder 204 includes second decoder layers 210 and a conditional generation head 208a.

As shown, the machine learning model 116 receives a triplet 126 that includes a training context 128, a first target question 130, and a second target question 132 (block 502). In particular, the first decoder 202 and the second decoder 204 receive the training context 128. In one or more implementations, the machine learning model 116 includes an encoder, i.e., the machine learning model 116 is a transformer having an encoder-decoder architecture. In accordance with these implementations, the encoder outputs an encoded context (e.g., a vector or matrix representation of the training context 128 in latent space) conditioned on the training context 128, and provides the encoded context to the first and second decoders 202, 204. In one or more alternative implementation, the machine learning model 116 does not include an encoder, i.e., the machine learning model 116 is a transformer having a decoder architecture. In accordance with these implementations, the training context 128 is provided directly to the first decoder 202 and the second decoder 204. In the following discussion, the training context 128 refers to an encoded version of the training context 128 or an unencoded version of the training context 128.

In accordance with the described techniques, the first decoder layers 206 output a first representation 212 (e.g., a matrix representation in latent space) of first candidate words to follow previous words 214a of the first target question 130 based on the training context 128 and the previous words 214a (block 504). Moreover, at each subsequent time step of the training process, the first decoder layers 206 output the first representation 212 based on an additional word of the first target question 130. Thus, the first decoder layers 206 output the first representation 212 based on the training context 128 and a start token indicating the beginning of a question during a first time step, the first decoder layers 206 output the first representation 212 based on the training context 128 and a first word of the first target question 130 during a second time step, the first decoder layers 206 output the first representation 212 based on the training context 128 and the first two words of the first target question 130 during a third time step, and so on.

During each respective time step, the first representation 212 is generated by propagating the first representation 212 through the various layers of the first decoder layers 206. In a particular time step, for example, a first layer of the first decoder 202 outputs a first version of the first representation 212 conditioned on the training context 128 and the previous words 214a of the first target question 130 (or the start token). Moreover, the first version of the first representation 212 is fed forward to a second layer of the first decoder 202, which outputs a second version of the first representation 212 conditioned on the training context 128 and the first version of the first representation 212. This process is repeated for each layer of the first decoder 202, in which each subsequent layer of the first decoder 202 is conditioned on the training context 128 and the first representation 212 as output by a previous layer. The first representation 212 output collectively by the first decoder layers 206, therefore, is the first representation 212 as output by a final layer of the first decoder 202.

Furthermore, the second decoder layers 210 are configured to output a second representation 216 (e.g., a matrix representation in latent space) of second candidate words to follow previous words 214b of the second target question 132 based on the training context 128 and the previous words 214b (block 506). Similar to the first decoder layers 206, the second decoder layers 210 are conditioned on an additional word of the second target question 132 at each subsequent time step of the training process. For example, the second decoder layers 210 output the second representation 216 based on the training context 128 and the start token during a first time step, the second decoder layers 210 output the second representation 216 based on the training context 128 and a first word of the second target question 132 during a second time step, the second decoder layers 210 output the second representation 216 based on the training context 128 and a first two words of the second target question 132 during a third time step, and so on.

Similar to the first representation 212, the second representation 216 is generated by propagating the second representation 216 through the various layers of the second decoder layers 210. In a particular time step, for example, a first layer of the second decoder 204 outputs a first version of the second representation 216 conditioned on the training context 128 and the previous words 214b of the second target question 132 (or the start token). Moreover, the first version of the second representation 216 is fed forward to a second layer of the second decoder 204, which outputs a second version of the second representation 216 conditioned on the training context 128 and the first version of the second representation 216. This process is repeated for each layer of the second decoder 204, in which each subsequent layer of the second decoder 204 is conditioned on the training context 128 and the second representation 216 as output by a previous layer. The second representation 216 output collectively by the second decoder layers 210, therefore, is the second representation 216 as output by a final layer of the second decoder 204.

In the following discussion, a pair of corresponding layers of the first and second decoders 202, 204, respectively, are considered together as a single layer of a dual-decoder architecture including the first decoder 202 and the second decoder 204. By way of example, a first layer of the dual-decoder architecture includes the first layer of the first decoder 202 and the first layer of the second decoder 204, a second layer of the dual-decoder architecture includes the second layer of the first decoder 202 and the second layer of the second decoder 204, and so on. Given this, the first representation 212 and the second representation 216 as output by a respective layer, l, of the dual-decoder architecture are representable as:

$${h}_{d ( 1 )}^{l} = l ( c , {h}_{d ( 1 )}^{l - 1} ) \qquad ( 1 )$$

$${h}_{d ( 2 )}^{l} = l ( c , {h}_{d ( 2 )}^{l - 1} ) \qquad ( 2 )$$

In the equations above, c represents the training context 128 (e.g., in an encoded or an unencoded format), h_{d(1)}^{l-1} is the first representation 212 as output by a previous layer of the first decoder 202, h_{d(2)}^{l-1} is the second representation 216 as output by a previous layer of the second decoder 204. Moreover, h_{d(1)}⁰ represents the previous words 214a of the first target question 130 (or the start token), while h_{d(2)}⁰ represents the previous words 214b of the second target question 132 (or the start token). If the dual-decoder architecture includes a number of layers, l∈{1, 2, . . . , L}, then h_{d(1)}^{L} is the first representation 212 as output collectively by the first decoder layers 206, and h_{d(2)}^{L} is the second representation 216 as output collectively by the second decoder layers 210. Although the first decoder 202 and the second decoder 204 are described as including multiple layers, it is to be appreciated that the first decoder 202 and the second decoder 204 solely include one layer in variations.

As shown, the first decoder layers 206 provide the first representation 212 as input to a conditional generation head 208a of the first decoder 202. Similarly, the second decoder layers 210 provide the second representation 216 as input to a conditional generation head 208b of the second decoder 204. In one or more examples, the conditional generation heads are multi-layer perceptron (MLP) networks implemented using a feed-forward layer followed by a softmax operation.

In accordance with the described techniques, the conditional generation head 208a converts the first representation 212 to a probability distribution 218a, and the conditional generation head 208b converts the second representation 216 to a probability distribution 218b. As part of this, the conditional generation heads 208a, 208b assign probabilities to respective words in a library of words of the machine learning model 116. The probabilities of the probability distribution 218a represent measures of likelihood that the respective words follow the previous words 214a of the first target question 130. Similarly, the probabilities of the probability distribution 218b represent measures of likelihood that the respective words follow the previous words 214b of the second target question 132.

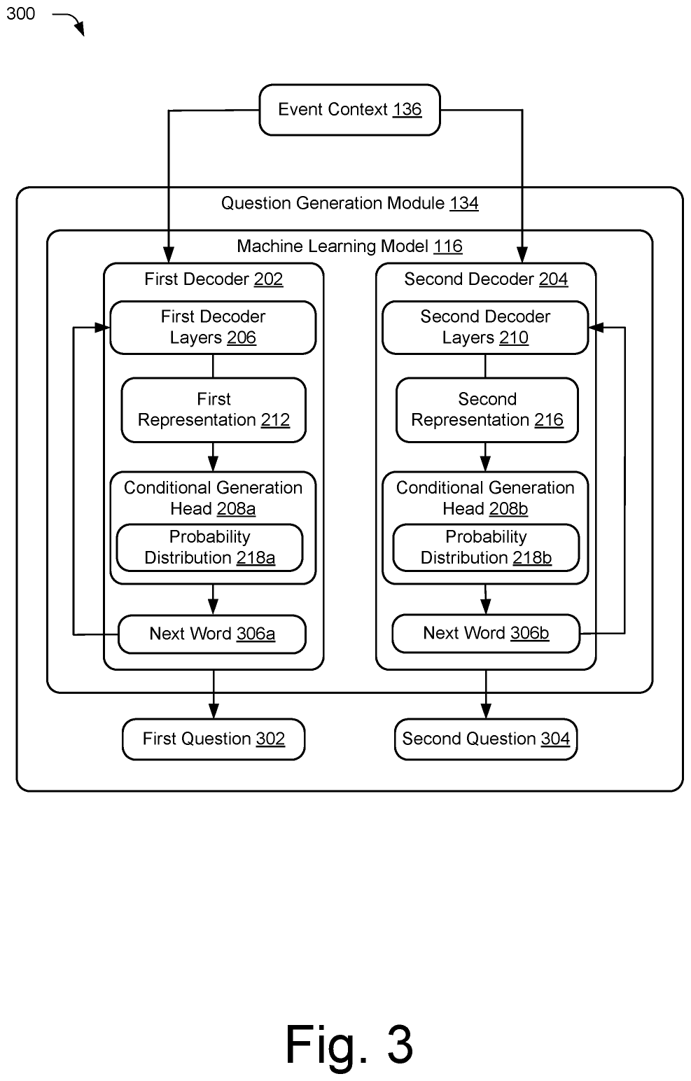

Moreover, the sum of probabilities of the probability distributions 218a, 218b totals a value of one. Given this, the words assigned a non-zero probability in the probability distribution 218a are referred to as first candidate words to follow the previous words 214a of the first target question 130. Similarly, the words assigned a non-zero probability in the probability distribution 218b are referred to as second candidate words to follow the previous words 214b of the second target question 132. During an inference phase, the first candidate word assigned a highest probability in the probability distribution 218a is selected to be a next word of a generated first question, and the second candidate word assigned a highest probability in the probability distribution 218b is selected to be a next word of a generated second question, as further discussed below with reference to FIG. 3.

Furthermore, the fine-tuning logic 120 is configured to fine-tune and/or train the machine learning model 116 to generate questions that are relevant to a given context based on relevance losses 220a, 220b. The relevance losses 220a, 220b are calculated by comparing the probability distributions 218a, 218b to a next word 222a, 222b of the first and second target questions 130, 132, respectively. The next words 222a, 222b are the words of the first and second target questions 130, 132 immediately following the previous words 214a, 214b of the first and second target questions 130, 132, respectively. In a fifth time step of the training process, for example, the previous words 214a include the first four words of the first target question 130, and the next word 222a is the fifth word of the first target question 130. Also in the fifth time step, the previous words 214b include the first four words of the second target question 132, and the next word 222b is the fifth word of the second target question 132.

The fine-tuning logic 120 calculates the relevance loss 220a based on the probability assigned to a first candidate word that matches the next word 222a of the first target question 130. By way of example, the relevance loss 220a is implemented as cross-entropy loss between the probability distribution 218a and a ground truth distribution in which the next word 222a is assigned a value of one and other words in the library are assigned a value of zero.

Similarly, the fine-tuning logic 120 calculates the relevance loss 220b based on a probability assigned to a second candidate word that matches the next word 222b of the second target question 132. For example, the relevance loss 220b is implemented as cross-entropy loss between the probability distribution 218b and a ground truth distribution in which the next word 222b is assigned a value of one and other words in the library are assigned a value of zero. Given this, a decreased value of the probabilities assigned to the matching first and second candidate words leads to an increased value for the relevance losses 220a, 220b.

In addition, the fine-tuning logic 120 is configured to fine-tune and/or train the machine learning model to generate diverse questions based on a diversity loss 224 that captures a degree of variance between the first representation 212 and the second representation 216 (block 508). In various examples, the diversity loss 224 is based on a plurality of pairwise diversity scores 226, in which a respective pairwise diversity score 226 captures a degree of variance between the first representation 212 and the second representation 216 as output by a respective layer of the dual-decoder architecture. By way of example, a first pairwise diversity score 226 is determined by applying a difference metric to the first representation 212 and the second representation 216 as output by the first layer of the first decoder 202 and the first layer of the second decoder 204, respectively. In addition, a second pairwise diversity score 226 is determined by applying a difference metric to the first representation 212 and the second representation 216 as output by the second layer of the first decoder 202 and the second layer of the second decoder 204, respectively, and so on. Notably, the diversity loss 224 is an average of the pairwise diversity scores 226.

In one or more implementations, the diversity loss 224 is representable as:

$$DivLoss = \frac{1}{L} {\sum }_{l = 1}^{L} cosine ( \overline{{h}_{d ( 1 )}^{( l )}} , \overline{{h}_{d ( 2 )}^{( l )}} ) \qquad ( 3 )$$

In equation (3), the dual-decoder architecture includes a number of layers l∈{1, 2, . . . , L}. Moreover, h̅_̅{̅d̅(̅1̅)̅}̅^̅{̅(̅l̅)̅}̅ is the first representation 212 as output by a respective layer, l, of the first decoder 202 and having a pooling function applied. In addition, \vec{h_{d(1)}^{(l)}} is the second representation 216 as output by the respective layer, l, of the second decoder 204 and having a pooling function applied. Any of a variety of pooling functions are implementable in accordance with the described techniques, including but not limited to a mean pooling function, a max pooling function, or a min pooling function.

Further, the cosine function is the difference metric applied to the first and second representations 212, 216 as output by the respective layer, while the

$$\frac{1}{L}$$

term serves to calculate an average of the pairwise diversity scores 226. Given the above, the pairwise diversity scores 226 increase (and, in turn, the diversity loss 224 increases) in correlation with a degree of similarity between the first and second representations 212, 216 as output by respective layers of the dual-decoder architecture.

In accordance with the described techniques, an overall loss value is calculated that includes the relevance losses 220a, 220b, as well as the diversity loss 224. Moreover, the fine-tuning logic 120 updates the machine learning model 116 to minimize the overall loss value. By way of example, the fine-tuning logic 120 updates weights of layers (e.g., input layers, output layers, hidden layers, self-attention layers, feed-forward layers, and/or linear layers) of the first decoder layers 206, the second decoder layers 210, and/or the conditional generation heads 208a, 208b to minimize the loss value. In implementations in which the machine learning model 116 includes an encoder, the fine-tuning logic 120 additionally updates weights of layers of the encoder.

During a subsequent time step, the machine learning model 116 is similarly employed to generate the first representation 212, the second representation 216, and the probability distributions 218a, 218b. However, the first decoder layers 206 and the second decoder layers 210 are conditioned on an additional word of the first and second target questions 130, 132, respectively, as previously discussed. The fine-tuning logic 120 is similarly configured to update the machine learning model 116 to reduce the relevance losses 220a, 220b and the diversity loss 224 during the subsequent time step. This process is repeated until there are no remaining words in the first and second target questions 130, 132. Moreover, this process is repeated on different triplets 126 of the training data 122 until a threshold number of triplets 126 have been processed or a threshold number of epochs have been processed.

By updating the machine learning model 116 based on the relevance losses 220a, 220b, the fine-tuning logic 120 enforces the machine learning model 116 to generate questions that correspond to the first and second target questions 130, 132. Accordingly, the machine learning model 116 learns to generate questions that are relevant to (e.g., likely to be asked with respect to) a given context. By updating the machine learning model 116 based on the diversity loss 224, the fine-tuning logic 120 enforces the dual-decoder architecture to output dissimilar representations of candidate words. Given this, the machine learning model 116 learns to maximize semantic diversity between questions generated for a given context.

Notably, the above-described training techniques utilize a teacher-forcing approach. That is, the first decoder 202 is conditioned on the previous words 214a of the first target question 130 rather than words output/generated by the first decoder 202. Similarly, the second decoder 204 is conditioned on the previous words 214b of the second target question 132 rather than words generated by the second decoder 204. By using the teacher-forcing approach, the described techniques prevent the compounding of errors made during previous time steps, which improves learning efficiency for the machine learning model 116.

The techniques further improve learning efficiency by updating the machine learning model 116 based on the pairwise diversity scores 226 measured between intermediate versions of the first representation 212 and the second representation 216. Indeed, the earlier layers of the machine learning model 116 learn question diversification based on a diversity loss 224 that directly accounts for the output of the earlier layers. As a result, the earlier layers learn question diversification with increased efficiency, as compared to a loss value that measures diversity based solely on the output of a final layer of the dual-decoder architecture.

In addition to the fine-tuning techniques described above, the fine-tuning logic 120 includes functionality for fine-tuning the machine learning model 116 to generate questions that cover information inadequately conveyed by a given context. Any of a variety of public or proprietary techniques are usable by the fine-tuning logic 120 to train the machine learning model 116 to generate questions that cover information that is missing from and/or inadequately covered by a given context, one example of which is described by Majumder et al., Ask what's missing and what's useful: Improving Clarification Question Generation using Global Knowledge, Proceedings of the 2021 Conference of the North American Chapter of the Association for Computational Linguistics: Human Language Technologies, 4300-4312 (2021), which is herein incorporated by reference in its entirety.

FIG. 3 depicts a system 300 in an example implementation showing operation of a question generation module to use the machine learning model. Broadly, the question generation module 134 employs the machine learning model 116 to generate a first question 302 and a second question 304 based on an event context 136. Further, the machine learning model 116 is fine-tuned to diversify the generated questions 302, 304 and relate the generated questions 302, 304 to the event context 136 in accordance with the techniques described above with reference to FIG. 2. During each time step of the question generation process, the first decoder 202 outputs a next word 306a of the first question 302 and the second decoder 204 outputs a next word 306b of the second question 304.

More specifically, the machine learning model 116 receives the event context 136. In implementations in which the machine learning model 116 includes an encoder, the encoder generates an encoded context (e.g., a vector or matrix representation of the event context 136) conditioned on the event context 136, and provides the encoded context to the decoders 202, 204. In implementations in which the machine learning model 116 does not include an encoder, the event context 136 is provided directly to the decoders 202, 204. In the following discussion, the event context 136 refers to an encoded version of the event context 136 or an unencoded version of the event context 136.

The first decoder 202 and the second decoder 204 are employed to generate the first representation 212 and the second representation 216, respectively, in a similar manner as that described above with reference to FIG. 2. However, during a given time step of the question generation process, the first decoder layers 206 receive, as conditioning, one or more words of the generated first question 302 rather than one or more words of the first target question 130. In addition, during a given time step of the question generation process, the second decoder layers 210 receive, as conditioning, one or more words of the generated second question 304 rather than one or more words of the second target question 132.

Thus, the first decoder layers 206 generate the first representation 212 based on the event context 136 and the start token during a first time step. During each subsequent time step, the first decoder layers 206 generate the first representation 212 based on the event context 136 and the words of the first question 302 generated during previous time steps. Further, during each respective time step, the first representation 212 is generated by propagating the first representation 212 through the various layers of the first decoder layers 206. As part of this, the first layer of the first decoder 202 outputs the first representation 212 based on the event context 136 and one or more words of the first question 302 (or the start token). Further, each subsequent layer of the first decoder 202 outputs the first representation 212 based on the event context 136 and the first representation 212 as output from a previous layer.

Similarly, the second decoder layers 210 generate the second representation 216 based on the event context 136 and the start token during a first time step. During each subsequent time step, the second decoder layers 210 generate the second representation 216 based on the event context 136 and the words of the second question 304 generated during previous time steps. Further, during each respective time step, the first representation 212 is generated by propagating the second representation 216 through the various layers of the second decoder layers 210. As part of this, the first layer of the second decoder 204 outputs the second representation 216 based on the event context 136 and one or more words of the second question 304 (or the start token). Further, each subsequent layer of the second decoder 204 outputs the second representation 216 based on the event context 136 and the second representation 216 as output from a previous layer.

As shown, the first representation 212 as output by a final layer of the first decoder layers 206 is provided, as input, to the conditional generation head 208a. Similarly, the second representation 216 as output by a final layer of the second decoder layers 210 is provided, as input, to the conditional generation head 208b. The conditional generation heads 208a, 208b convert the first and second representations 212, 216 to the probability distributions 218a, 218b, respectively, in a similar manner to that described above with reference to FIG. 2. By way of example, the probability distribution 218a includes probabilities assigned to first candidate words, and the probabilities represent measures of likelihood that the first candidate words are the next word 306a of the first question 302. Moreover, the probability distribution 218b includes probabilities assigned to second candidate words, and the probabilities represent measures of likelihood that the second candidate words are the next word 306b of the second question 304.

Furthermore, the conditional generation head 208a outputs, as the next word 306a of the first question 302, a respective one of the first candidate words assigned a highest probability in the probability distribution 218a. Similarly, the conditional generation head 208b outputs, as the next word 306b of the second question 304, a respective one of the second candidate words assigned a highest probability in the probability distribution 218b.

Moreover, the next words 306a, 306b are fed back to the first decoder layers 206 and the second decoder layers 210, respectively. Given this, the next word 306a of the first question 302 generated in the illustrated time step (t=i) along with the words of the first question 302 generated in previous time steps (t<i) are used to condition the first decoder layers 206 for generating the next word 306a of the first question 302 in a subsequent time step (t=i+1). Similarly, the next word 306b of the second question 304 generated in the illustrated time step (t=i) along with the words of the second question 304 generated in previous time steps (t<i) are used to condition the second decoder layers 210 for generating the next word 306b of the second question 304 in a subsequent time step (t=i+1). This process is repeated until the conditional generation heads 208a, 208b generate an end token instead of the next words 306a, 306b, which indicates completion of a respective generated question 302, 304.

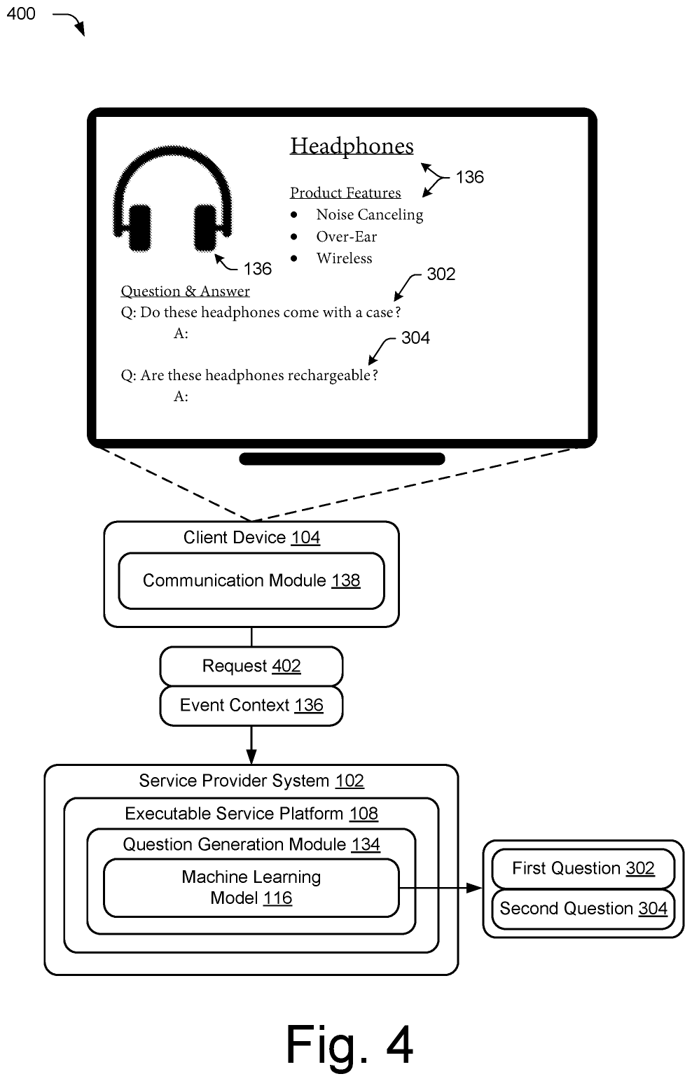

FIG. 4 depicts an example 400 in which a client device leverages the machine learning model as part of one or more digital services made available to the client device via a service provider system. In particular, the example 400 includes a client device 104 of a user having published a product listing using the digital services 110, e.g., digital marketplace services and/or auction services. In response to the user publishing the product listing, the client device 104 communicates the event context 136 and a request 402 to the service provider system 102. In the illustrated example 400, the event context 136 includes a title of the product listing and one or more product features of the product listing. Additionally or alternatively, the event context 136 includes a display photo of the product listing. Further, the request 402 is for access to the question generation module 134 as part of the digital services 110 made available to the client device 104 via the executable service platform 108.

In response, the service provider system 102 employs the question generation module 134 to generate the first question 302 and the second question 304. As part of this, the question generation module 134 leverages the machine learning model 116 to generate the first question 302 and the second question 304 based on the event context 136 in accordance with the techniques discussed above with reference to FIG. 3. Moreover, the machine learning model 116 is fine-tuned to diversify the generated questions 302, 304 and relate the generated questions 302, 304 to the event context 136 in accordance with the techniques described above with reference to FIG. 2.

Further, the service provider system 102 outputs the first question 302 and the second question 304. In the illustrated example 400, the service provider system 102 outputs the first question 302 and the second question 304 by populating a “Question & Answer” section with the generated questions 302, 304. In another non-limiting example, the service provider system 102 outputs the generated questions 302, 304 by communicating the questions 302, 304 back to the client device 104 of the user that published the product listing. In response to receiving the questions 302, 304, the client device 104 displays (e.g., via a user interface) the questions 302, 304 along with a user interface element that is selectable to insert the questions 302, 304 into the “Question & Answer” section.

### Example System and Device

FIG. 6 illustrates an example system 600 that includes an example computing device 602 that is representative of one or more computing systems and/or devices that implement the various techniques described herein. This is illustrated through inclusion of the comment module 112. The computing device 602 is configurable, for example, as a server of a service provider, a device associated with a client (e.g., a client device 104), an on-chip system, and/or any other suitable computing device or computing system.

The example computing device 602 as illustrated includes a processing device 604, one or more computer-readable media 606, and one or more input/output (I/O) interfaces 608 that are communicatively coupled, one to another. Although not shown, the computing device 602 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing device 604 is representative of functionality to perform one or more operations using hardware. Accordingly, the processing device 604 is illustrated as including hardware element 610 that is configurable as processors, functional blocks, and so forth. This includes implementation in hardware as an application specific integrated circuit or other logic device formed using one or more semiconductors. The hardware elements 610 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically executable instructions.

The computer-readable storage media 606 is illustrated as including memory/storage 612 that stores instructions that are executable to cause the processing device 604 to perform operations. The memory/storage 612 represents memory/storage capacity associated with one or more computer-readable media. The memory/storage 612 includes volatile media (such as random access memory (RAM)) and/or nonvolatile media (such as read only memory (ROM), Flash memory, optical disks, magnetic disks, and so forth). The memory/storage 612 includes fixed media (e.g., RAM, ROM, a fixed hard drive, and so on) as well as removable media (e.g., Flash memory, a removable hard drive, an optical disc, and so forth). The computer-readable media 606 is configurable in a variety of other ways as further described below.

Input/output interface(s) 608 are representative of functionality to allow a user to enter commands and information to computing device 602, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 602 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 602. By way of example, and not limitation, computer-readable media includes “computer-readable storage media” and “computer-readable signal media.”

“Computer-readable storage media” refers to media and/or devices that enable persistent and/or non-transitory storage of information (e.g., instructions are stored thereon that are executable by a processing device) in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 602, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 610 and computer-readable media 606 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 610. The computing device 602 is configured to implement particular instructions and/or functions corresponding to the software and/or hardware modules. Accordingly, implementation of a module that is executable by the computing device 602 as software is achieved at least partially in hardware, e.g., through use of computer-readable storage media and/or hardware elements 610 of the processing device 604. The instructions and/or functions are executable/operable by one or more articles of manufacture (for example, one or more computing devices 602 and/or processing devices 604) to implement techniques, modules, and examples described herein.

The techniques described herein are supported by various configurations of the computing device 602 and are not limited to the specific examples of the techniques described herein. This functionality is also implementable all or in part through use of a distributed system, such as over a “cloud” 614 via a platform 616 as described below.

The cloud 614 includes and/or is representative of a platform 616 for resources 618. The platform 616 abstracts underlying functionality of hardware (e.g., servers) and software resources of the cloud 614. The resources 618 include applications and/or data that can be utilized while computer processing is executed on servers that are remote from the computing device 602. Resources 618 can also include services provided over the Internet and/or through a subscriber network, such as a cellular or Wi-Fi network.

The platform 616 abstracts resources and functions to connect the computing device 602 with other computing devices. The platform 616 also serves to abstract scaling of resources to provide a corresponding level of scale to encountered demand for the resources 618 that are implemented via the platform 616. Accordingly, in an interconnected device embodiment, implementation of functionality described herein is distributable throughout the system 600. For example, the functionality is implementable in part on the computing device 602 as well as via the platform 616 that abstracts the functionality of the cloud 614.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method, comprising:
receiving, by a machine learning model, a first target question, a second target question, and a context;
outputting, by a first decoder of the machine learning model, a first representation of first candidate words to follow one or more words of the first target question based on the context and the one or more words of the first target question;
outputting, by a second decoder of the machine learning model, a second representation of second candidate words to follow one or more words of the second target question based on the context and the one or more words of the second target question; and
training the machine learning model to generate diverse questions for a given context based on a diversity loss that captures a degree of variance between the first representation and the second representation.

2. The method of claim 1, further comprising:
converting the first representation into a first probability distribution including probabilities that individual words of the first candidate words follow the one or more words of the first target question; and
converting the second representation into a second probability distribution including probabilities that individual words of the second candidate words follow the one or more words of the second target question.

3. The method of claim 2, wherein the training includes training the machine learning model to generate questions that are relevant to the given context based on a first probability assigned to a respective one of the first candidate words that matches a next word of the first target question, and a second probability assigned to a respective one of the second target question that matches a next word of the second target question.

4. The method of claim 1, wherein the machine learning model is a pre-trained natural language processing model, and the training includes fine-tuning the pre-trained natural language processing model to generate diverse questions for the given context.

5. The method of claim 1, wherein the machine learning model is a transformer having an encoder-decoder architecture.

6. The method of claim 1, wherein the machine learning model is a transformer having a decoder architecture.

7. The method of claim 1, wherein the first decoder and the second decoder each include a plurality of layers, respective subsequent layers of the first decoder updating the first representation based on the context and the first representation as output from respective previous layers of the first decoder, and respective subsequent layers of the second decoder updating the second representation based on the context and the second representation as output from respective previous layers of the second decoder.

8. The method of claim 7, wherein the training includes calculating the diversity loss by applying a difference metric to respective word representation pairs, the respective word representation pairs including the first representation and the second representation as output by corresponding layers of the first decoder and the second decoder.

9. A computing device, comprising:
a processing device; and
a computer-readable storage medium storing instructions that, responsive to execution by the processing device, causes the processing device to perform operations including:
receiving, by a machine learning model that includes a plurality of layers, a first target sentence, a second target sentence, and a context;
outputting, by each respective layer of the machine learning model, a pair of representations based, in part, on the context, each respective pair including a first representation of first candidate words to follow one or more words of the first target sentence and a second representation of second candidate words to follow one or more words of the second target sentence; and
training the machine learning model to generate diverse sentences for a given context based on a diversity loss that captures degrees of variance between each respective pair of representations.

10. The computing device of claim 9, the operations further comprising:
converting the first representation as output by a final layer of the plurality of layers into a first probability distribution including probabilities that individual words of the first candidate words follow the one or more words of the first target sentence; and
converting the second representation as output by the final layer into a second probability distribution including probabilities that individual words of the second candidate words follow the one or more words of the second target sentence.

11. The computing device of claim 10, wherein the training includes training the machine learning model to generate sentences that are relevant to the given context based on a first probability assigned to a respective one of the first candidate words that matches a next word of the first target sentence, and a second probability assigned to a respective one of the second candidate words that matches a next word of the second target sentence.

12. The computing device of claim 9, wherein the machine learning model is a pre-trained natural language processing model, and the training includes fine-tuning the pre-trained natural language processing model to generate diverse sentences for the given context.

13. The computing device of claim 9, wherein the machine learning model is a transformer having an encoder-decoder architecture.

14. The computing device of claim 9, wherein the machine learning model is a transformer having a decoder architecture.

15. One or more computer-readable storage media storing instructions that, responsive to execution by a processing device, causes the processing device to perform operations including:
receiving, by a machine learning model, a context;
generating, by the machine learning model, a first question and a second question based on the context, the machine learning model trained to diversify the first question and the second question by employing the machine learning model to generate representations of candidate words for inclusion in training questions and updating the machine learning model based on differences between the generated representations; and
outputting, by the machine learning model, the first question and the second question.

16. The one or more computer-readable storage media of claim 15, wherein the machine learning model is further trained to relate the first question and the second question to the context by assigning probabilities to the candidate words indicating measures of likelihood that the candidate words correspond to words of the training questions and updating the machine learning model based on respective ones of the probabilities assigned to the candidate words that match the words of the training questions.

17. The one or more computer-readable storage media of claim 15, wherein the context is retrieved from a product listing of a digital marketplace, the context including a title of the product listing.

18. The one or more computer-readable storage media of claim 17, wherein the outputting includes communicating the first question and the second question to a client device of a publisher of the product listing.

19. The one or more computer-readable storage media of claim 17, wherein the outputting includes automatically inserting the first question and the second question into a comments section of the product listing.

20. The one or more computer-readable storage media of claim 17, wherein the machine learning model is a transformer having an encoder-decoder architecture or a decoder architecture.
